(19) United States
(12) Patent Application Publication
(10) Pub. No.: US 2017/0255285 A1
(43) Pub. Date: Sep. 7, 2017

(54) DETACHABLE BACK MOUNTED TOUCHPAD FOR A HANDHELD COMPUTERIZED DEVICE

(71) Applicant: Handscape Inc., a Delaware Corporation, Fremont, CA (US)

(72) Inventor: Tong Luo, Fremont, CA (US)

(21) Appl. No.: 15/472,263

(22) Filed: Mar. 28, 2017

Related U.S. Application Data
(63) Continuation-in-part of application No. 15/239,652, filed on Aug. 17, 2016.
Application No. 15/239,652 is a continuation-in-part of application No. 14/491,671, filed on Sep. 19, 2014.
Application No. 14/491,671 is a continuation-in-part of application No. 13/770,791, filed on Feb. 19, 2013, now Pat. No. 9,311,724.
Application No. 13/770,791 is a continuation-in-part of application No. 13/223,836, filed on Sep. 1, 2011, now Pat. No. 9,310,905.
Application No. 13/223,836 is a continuation-in-part of application No. 12/773,075, filed on May 4, 2010, now Pat. No. 8,384,683.
(60) Provisional application No. 61/327,102, filed on Apr. 23, 2010.

(51) Int. Cl. G06F 3/0354; G06F 1/16; G06F 1/18; G06F 3/041

(52) U.S. Cl. CPC G06F 3/03547; G06F 3/0416; G06F 1/1626; G06F 1/189; G06F 2203/04104; G06F 3/016

(57) ABSTRACT

The present invention relates to a detachable touchpad for a handheld computerized device. This detachable touchpad is configured to reversibly attach to the back of a handheld computerized device that lacks a rear mounted touchpad, and with appropriate software, allow the user to at least in part control the handheld computerized device from behind the device. In some embodiments, the detachable touchpad may further separate into a left and right hand section when detached from the computerized device, and may alternatively or additionally also have an optional second touchpad that is normally hidden from the user when the touchpad is attached to the computerized device, but which is exposed when the touchpad is removed from the computerized device. The detachable touchpad may be also equipped with various optional haptic transducers, motion sensors, and other types of sensors.

### CROSS REFERENCE TO RELATED APPLICATIONS

This application is a continuation in part of application Ser. No. 15/239,652, “FRONT TOUCHSCREEN AND BACK TOUCHPAD OPERATED USER INTERFACE EMPLOYING SEMI-PERSISTENT BUTTON GROUPS”, filed Aug. 17, 2016; application Ser. No. 15/239,652 is a continuation in part of application Ser. No. 14/491,671, “METHOD FOR CONTROLLING A CONTROL REGION OF A COMPUTERIZED DEVICE FROM A TOUCHPAD”, filed Sep. 19, 2014; application Ser. No. 14/491,671 was a continuation in part of application Ser. No. 13/770,791, “METHOD FOR USER INPUT FROM ALTERNATIVE TOUCHPADS OF A HANDHELD COMPUTERIZED DEVICE”, filed Feb. 19, 2013, now U.S. Pat. No. 9,311,724 issued Apr. 12, 2016; application Ser. No. 13/770,791 is a continuation in part of application Ser. No. 13/223,836, filed Sep. 1, 2011, now U.S. Pat. No. 9,310,905 issued Apr. 12, 2016; application Ser. No. 13/223,836 was a continuation in part of U.S. patent application Ser. No. 12/773,075, “METHOD FOR USER INPUT FROM THE BACK PANEL OF A HANDHELD COMPUTERIZED DEVICE”, filed May 4, 2010, now U.S. Pat. No. 8,384,683, issued Feb. 26, 2013; application Ser. No. 12/773,075 in turn claimed the priority benefit of U.S. Provisional Application No. 61/327,102 filed Apr. 23, 2010, entitled “METHOD, GRAPHICAL USER INTERFACE, AND APPARATUS FOR USER INPUT FROM THE BACK PANEL OF A HANDHELD ELECTRONIC DEVICE”; the contents of all of these applications are incorporated herein by reference.

### BACKGROUND OF THE INVENTION

Field of the Invention

The invention is in the general area of touchpads and touch sensors for handheld computerized devices.

Description of the Related Art

Handheld computerized devices (i.e. handheld devices equipped with microprocessors, bit-mapped displays, and often touch sensitive displays) such as cell phones, personal digital assistants (PDA), game devices, tablet PCs (such as iPad), etc., are playing a more and more important role in everyday life, and are becoming more and more indispensible. With the advance of technology, and improvements in the handheld computerized devices' processing power, both function, and memory space is increasing at an amazing pace. Meanwhile the size of the handheld computerized devices continues to get smaller and smaller.

To meet this challenge, the designers of handheld computerized devices typically use two approaches. One approach is to make the keyboard keys smaller and smaller, miniaturizing the keys. Additionally the keyboard keys may be given multiple functions—i.e. overloaded, and more complex function keyboard keys may be introduced as well.

The other approach is to make the display a touch sensitive display, and use touch screen keyboards, or so called “soft keys”. Here a user may use a stylus pen or finger to select the soft keys through a graphical user interface. Due to the optical illusions introduced by the display screen, however, the soft keys cannot be too small, because otherwise a single finger press will activate multiple keys. As a result, the designer may have to divide the keys into different groups and hierarchies, and only display a small number of keys on the screen.

Both current approaches have some severe drawbacks: the user input area can occupy a significant portion of the front panel, and the user input process, although requiring a large amount of user attention to operate, still is very error prone.

Often a user has to use one hand to hold the handheld computerized device, and use the other hand to input data, thus occupying both hands. A user will often have to go through a long sequence of key strokes, and switch back and forth among different user interface screens, in order to complete a fairly simple input. As a result, there is a significant learning curve for a user to learn the overloaded keys, function keys, key grouping, and key hierarchies in order to operate the handheld computerized devices efficiently.

To simplify the user interface, various alternative methods employing touch sensors, touchpads, touch screens and the like (also called touch sensitive input devices and trackpads) have been proposed.

Yoon et. al., in U.S. patent application Ser. No. 12/691,892, proposed a mobile terminal having a dual touch screen and method of controlling content therein. This patent application disclosed a handheld computerized device with two built-in touch sensors, one located on the device's front touch screen, and a second touchpad sensor located on the rear of the device.

Cholewin et. al. in U.S. patent application Ser. No. 12/505,755, as well as Gorsica et. al. in U.S. patent application Ser. No. 12/492,369, proposed various types of portable handheld computerized devices with either opposing built-in touch sensitive surfaces, or alternatively constructing handheld computerized devices with the touchpad on the rear surface.

Luo, in U.S. provisional patent application 61/327,102, and U.S. non-provisional patent application Ser. No. 12/773,075 (now U.S. Pat. No. 8,384,683), both of which are incorporated herein by reference, introduced a method that utilized a back mounted touchpad. This method took touch input data from this back mounted touchpad, and used software models of the hand to in turn generate a virtual image of the most likely user rear hand position, often superimposed upon a virtual keyboard layout. The net effect was to attempt to make the handheld computerized device “transparent”, thus allowing the user to visualize the most likely position of his hands and fingers that were otherwise hidden because they were behind the device. Thus the method allowed the user to use a touchpad keypad on the back of the device to input keystrokes and mouse actions, and this touchpad data was reflected on the display screen on the front of the handheld computerized device as “virtual fingers” or equivalent.

### BRIEF SUMMARY OF THE INVENTION

The invention is based, in part, on the insight that the vast majority of handheld computerized devices do not incorporate touchpads on the back side of the device, and further on the insight that due to competitive cost pressures on the handheld computerized device industry, back side mounted touchpads are not likely to become a standard feature of such handheld computerized devices.

The invention is also based, in part, on the insight that the functionality of many popular handheld computerized devices can be extended by way of various types of software, either by running various software applications programs (apps) on top of the computerized device's basic operating system, or by modifying the operating system software itself. Further, many such popular handheld computerized devices have various data input mechanisms—input ports, short range wireless transceivers (e.g. Bluetooth™ transceivers), audio input/output jacks, and the like by which peripherals may be added to the handheld computerized device, thereby extending its functionality.

The invention is also based, in part, on the insight that it would be desirable to produce a touchpad peripheral configured to reversibly attach to the back surface of a handheld computerized device. Such a detachable back mounted touchpad could, in conjunction with appropriate applications software or appropriate modifications to the underlying operating system software, function to improve the user interface of the handheld computerized device in many ways. In some embodiments, the invention's back mounted touchpad peripheral could be used to bring the dual front- and back touching user interface concepts of Yoon to a handheld computerized device that otherwise would not be capable of implementing such a user interface. In other embodiments, the invention's back mounted touchpad peripheral could be used to bring the virtual fingers concepts of Luo to handheld computerized devices not otherwise capable of implementing such a user interface, and so on.

Thus in one embodiment, the invention may be a detachable touchpad device configured to reversibly attach to the back side of a handheld computerized device. Generally this handheld computerized device, which may be a smart phone, tablet computer, and the like will comprise at least a front side with a display screen, a back side without any touch input sensing devices, at least one processor, memory, and at least operating system software, such as Apple iOS, Android, Windows, Linux, and the like.

The invention's detachable touchpad device will generally comprise a cover configured to reversibly attach to part or all of the back side of the handheld computerized device. This cover will itself have a cover font side configured to face the back side of the handheld computerized device, and a cover back side opposite the cover front side that is configured to face away from the back side of the handheld computerized device. As a result, when the cover is attached to the handheld computerized device, the cover's back side can make contact with the hand of a user who is operating the computerized device from behind. The cover will generally have at least one touch sensing pad disposed to detect rear touch input from the user. To communicate touch data from the touch sensing pad, the detachable touchpad device will further have at least one data transfer device to communicate this touch input from the touch sensing pad to the handheld computerized device microprocessor(s) (processor). Thus when the detachable touchpad device is attached to the back side of the handheld computerized device, touch input from the user can be used to control the handheld computerized device.

In some embodiments, the user may also desire to occasionally detach the detachable touchpad device from the handheld computerized device, operate the handheld computerized device for at least a period of time in a detached mode, and then reattach the detachable touchpad device to the handheld computerized device and continue to operate the handheld computerized device as described above.

In this temporary detached mode, the user may wish to have the detachable touchpad device perform additional functions. For example, the user may wish to briefly use the detachable touchpad device as a game controller. Here additional functions and devices, such as the ability to separate into a left hand and right hand portion, incorporation of motion sensors, haptic sensors (e.g. causing the handheld touchpad device to vibrate upon receiving commands from the handheld computerized device) and the like may be useful. Additionally when the detachable touchpad device is detached from the handheld computerized device, an additional surface of the detachable touchpad device, normally covered when the detachable touchpad device is attached to the handheld computerized device, is now exposed. This formerly hidden surface may be used for additional functions, such as, for example incorporation of a second touchpad sensor into the formerly hidden surface of the detachable touchpad device.

When the user is finished with this “game controller” type operation, the user can once again snap or attach the detachable touchpad device onto the handheld computerized device, and continue to operate the handheld computerized device as described in the beginning of this section.

### BRIEF DESCRIPTION OF THE SEVERAL VIEWS OF THE DRAWINGS

FIGS. 1A, 1B, 1C, and 1D show a comparatively hard or rigid or semi-rigid body, clip-on embodiment of a detachable touchpad device with a built in touchpad on the back surface.

FIGS. 2A, 2B, 2C, and 2D show a slip-on embodiment of a detachable touchpad device with a built-in touchpad on the back surface.

FIGS. 3A, 3B, 3C, and 3D show an embodiment in which the detachable touchpad device with a built in touchpad communicates with the handheld computerized device via a fixed communications/power connector, in this example positioned at the bottom of the detachable touchpad device.

FIGS. 3E and 3F show a variant on the device previously shown in FIG. 3A, in which the cell phone slips down into the detachable touchpad device from above.

FIGS. 4A and 4B show examples of various alternative direct electrical cables, electrical connectors, and wireless links that can be used to communicate touch input from the built-in touchpad on the back surface of the detachable touchpad device, to the handheld computerized device.

FIG. 5 shows an example of how one or more microprocessors onboard the handheld computerized device may accept data from the detachable touchpad device's built-in touchpad on the back surface, and with the appropriate software, and in some embodiments in conjunction with touch data from the handheld computerized device's own front-mounted touch screen, control the operation and display of the handheld computerized device.

FIGS. 6A and 6B show the user's hand and fingers touching the built-in touchpad on the back surface of the detachable touchpad device, and how in the preferred multi-touch embodiment, the back touchpad will recognize the position and locations of at least two points of contact between the user's fingers and the back touchpad, and transmit this data to the handheld computerized device. In this example, software onboard the handheld computerized device may additionally be generating a representation of the approximate locations of the user's fingers and hand on the computerized devices' display screen.

FIGS. 7A and 7B show that in some embodiments, the detachable touchpad device may comprise two sections, each with its own rigid non-foldable cover, thus essentially splitting the detachable touchpad device into two detachable touchpad device sections. Additionally, in some embodiments, the one or more detachable touchpad device sections may also comprise a second touchpad on the front side of the touchpad device that may be hidden from the user when the at least one detachable touchpad device (section) is attached to the handheld computerized device, but is available for use when the at least one detachable touchpad device section is detached from the handheld computerized device.

FIGS. 8A and 8B show an example of a user using a detachable touchpad device with two sections, each with a rigid non-foldable cover in the detached configuration, thus essentially creating two detachable touchpad device sections. Here the user can, for example, use one detachable device section in a left hand, and the other detachable device section in the right hand.

FIGS. 9A and 9B show an embodiment where the detachable touchpad device is further configured to comprise haptic transducers and motion sensors. Here one of two detachable touchpad device sections is shown vibrating due to the haptic transducer, while the other detachable touchpad device section is shown detecting user hand motion. Both are in wireless communication with the handheld computerized device shown in FIG. 9C.

FIG. 9C shows the handheld computerized device, here in communication with the detachable touchpad device sections previously shown in FIGS. 9A and 9B.

FIG. 9D shows that the two detachable touchpad device sections previously shown in FIG. 9A can also both be attached to the back of the handheld computerized device, and in this configuration continue to operate as a single section as per the configuration previously described in FIGS. 6A and 6B.

FIG. 10 shows a modified version of the diagram previously shown in FIG. 5, here modified to show how a detachable touchpad device with two sections, each with a rigid non-foldable cover in the detached configuration can be electrically configured, as well as showing how additional components, such as haptic transducers, motion sensors, and other sensors may be implemented.

### DETAILED DESCRIPTION OF THE INVENTION

As previously discussed, in one embodiment, the invention may be a detachable touchpad device configured to reversibly attach to the back side of a handheld computerized device.

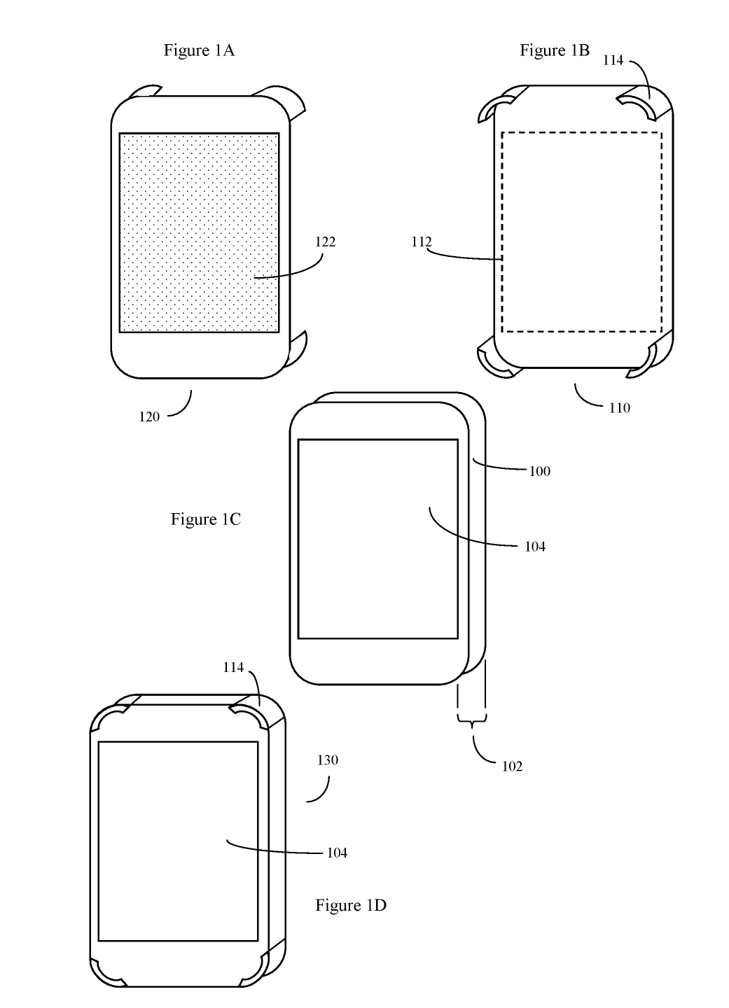

FIGS. 1A, 1B, and 1D show a hard-body (rigid-body or semi-rigid body), clip-on embodiment of a detachable touchpad device with a built in touchpad on the back surface.

As previously discussed, generally the handheld computerized device (FIG. 1C, 100) may be a smart phone, tablet computer, and the like. In these illustrations, in order to better show the depth (102) of the handheld device, a relatively thick handheld device, modeled roughly after the Apple iPhone 4 is shown, but of course other thicknesses, screen sizes, and input and output port configurations may be used.

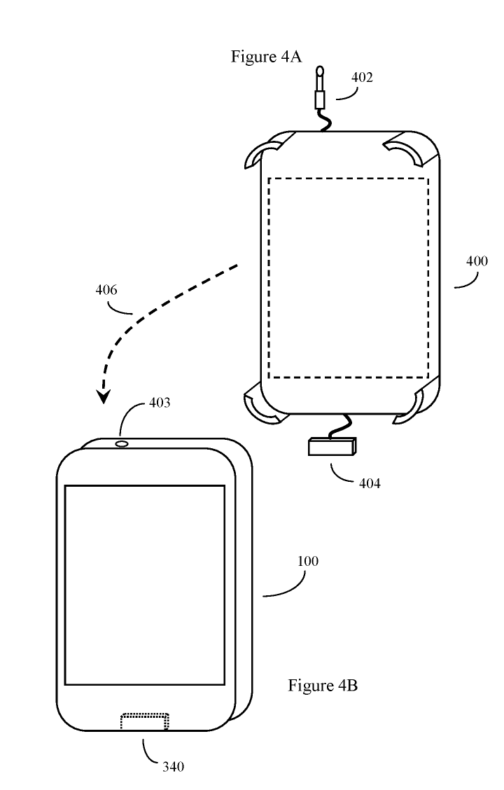

Such handheld computerized devices generally comprise at least a front side with a display screen (104), which is often a touch sensitive display screen (touch screen). These devices also usually comprise a back side generally disposed on the side of the device opposite to the front side. Typically such backsides, which are often configured to lie on support surfaces (e.g. tables), usually do not have any touch input sensing devices. As will be discussed in more detail in FIG. 5, such handheld computerized devices generally comprise, at least one processor, memory, and at least operating system software, such as Apple iOS, Android, Windows, Linux, and the like. Usually such handheld computerized devices also comprise one or more input or input/output ports, short range wireless transceivers, and the like.

In FIGS. 1A, 1B and 1D, the hard (rigid or semi-rigid) body, clip-on embodiment of a detachable touchpad device with a built-in touchpad on its back surface is shown showing both the detachable touchpad device's front side (110) and back side (120). In this configuration, the hard or rigid body of this clip-on may be made from a rigid or semi-rigid but slightly deformable material, such as hard rubber (which may be synthetic rubber), plastic or metal, in order to confer enough rigidity to clip on relatively firmly once attached, yet still deform enough to enable the device to be reversibly attached or detached by the user as desired.

The detachable touchpad device (110), (120) will generally comprise a cover configured to reversibly attach to at least part or all of the back side of the handheld computerized device shown in FIG. 1C (in these figures, the device is covering all of the handheld computerized device's backside). This cover will itself have a cover font side (110) configured to face the back side of the handheld computerized device, and a cover back side opposite the cover front side (120) that is configured to face away from the back side of the handheld computerized device. As a result, when the cover is attached to the handheld computerized device (130), the cover's back side can make contact with the hand of a user who is operating the computerized device. The back side of the cover (120) will generally have at least one touch sensing pad (122) (occasionally called a first at least one touch sensing pad) disposed to detect touch input from the user. The outline showing the approximate location of this touch sensing pad is also shown on the front cover (110) as (112). In this embodiment, the detachable touchpad device clips (110), (120) on to the handheld computerized device (FIG. 1C, 100) by way of clips (114), thus creating a handheld computerized device with a rear mounted touchpad (FIG. 1D, 130).

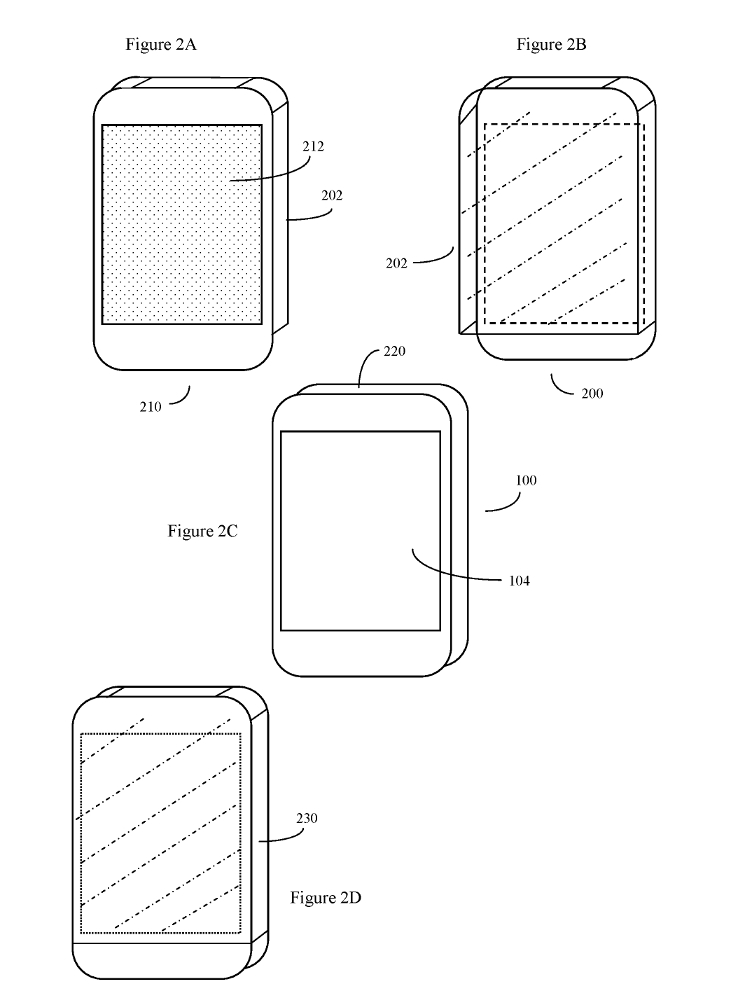

FIGS. 2A, 2B, and 2D show a slip-on embodiment of a detachable touchpad device with a built-in touchpad on the back surface, again from both the front cover (200) and rear cover (210) perspective. This embodiment also shows that the detachable touchpad device does not necessarily need to be rigid. Rather, in this example, the front of the detachable device (202) may have a pouch (202) configured to slip over the top (220) of the handheld computerized device (FIG. 2C, 100). Some or all of this pouch may be made from a transparent flexible material such as Mylar or other deformable transparent plastic. Thus when the detachable touchpad device is slipped onto the handheld computerized device (FIG. 2D, 230), the user may still see and interact with the handheld computerized device's display screen (104), while also being able to interact with the touch sensing pad on the back side of the detachable touchpad device.

To communicate touch data from the touch sensing pad, the detachable touchpad device will further have at least one data transfer device to communicate this touch input from the touch sensing pad to the handheld computerized device microprocessor(s) (processor).

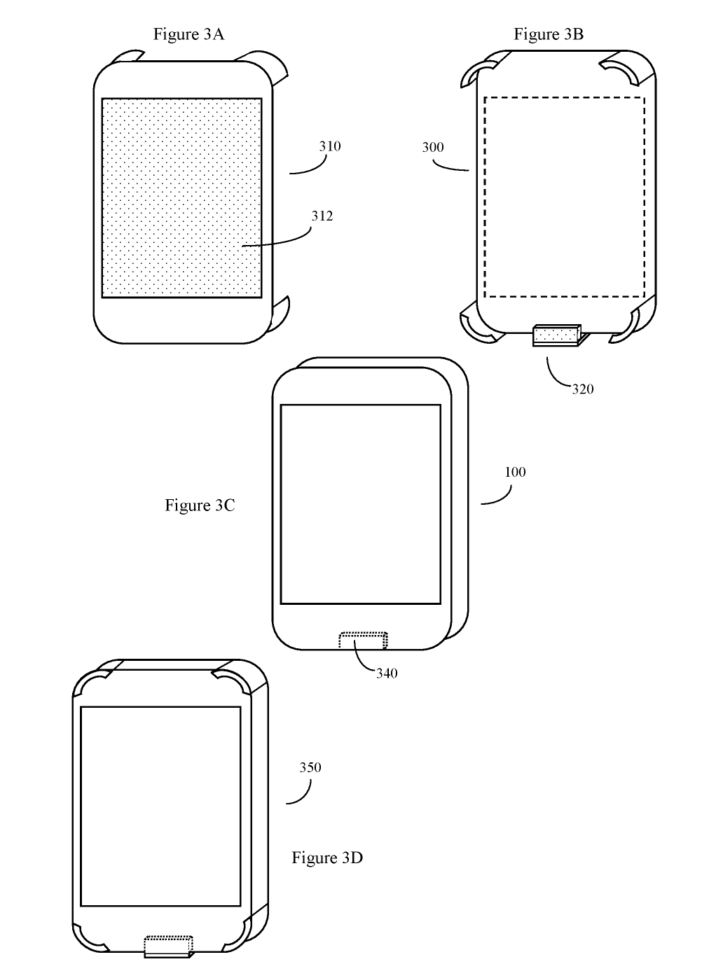

FIGS. 3A, 3B, and 3D show an embodiment in which the detachable touchpad device with a built in touchpad (312) (front and back sides shown as (300) and (310) communicates with the handheld computerized device via a fixed communications/power connector (320), such as a USB connector or Lightning connector, in this example positioned at the bottom of the detachable touchpad device.

The communications/power connector (320) must at least be a communications connector or data input connector to enable input from the touch sensing pad to be sent to the handheld computerized device processor. Here the connector (320) may be configured so as to readily plug into a socket or complementary connector (340) on the handheld computerized device (FIG. 3C, 100). The resulting configuration where the detachable touchpad device (300) is attached to the handheld computerized device (100) is shown in (FIG. 3D, 350).

In some embodiments, this connector (320) may also borrow electrical power from the handheld computerized device to operate the detachable touchpad device. In other embodiments, for example if the detachable touchpad device is configured with its own battery, then the connector (320) may optionally be used to charge the handheld computerized device (100).

FIGS. 3E, 3F, and 3H show an alternate top-slip on embodiment in which the detachable touchpad device with a built in touchpad (312) (front and back sides shown as (360) and (370)) slips into the device from the top (375), and then again communicates with the handheld computerized device (FIG. 3G, 100) via a fixed communications/power connector (320), in this example positioned at the bottom of the detachable touchpad device (see FIG. 3F).

As before, the communications/power connector (320) must at least be a communications connector or data input connector to enable input from the touch sensing pad to be sent to the handheld computerized device processor. Here again the connector (320) may be configured so as to readily plug into a socket or complementary connector (340) on the handheld computerized device (100). The resulting configuration where the detachable touchpad device (360/370) is attached to the handheld computerized device (100) is shown in (FIG. 3G, 380).

As before in some embodiments, this connector (320) may again borrow electrical power from the handheld computerized device to operate the detachable touchpad device. In other embodiments, for example if the detachable touchpad device is configured with its own battery, then the connector (320) may optionally be used to charge the handheld computerized device (100).

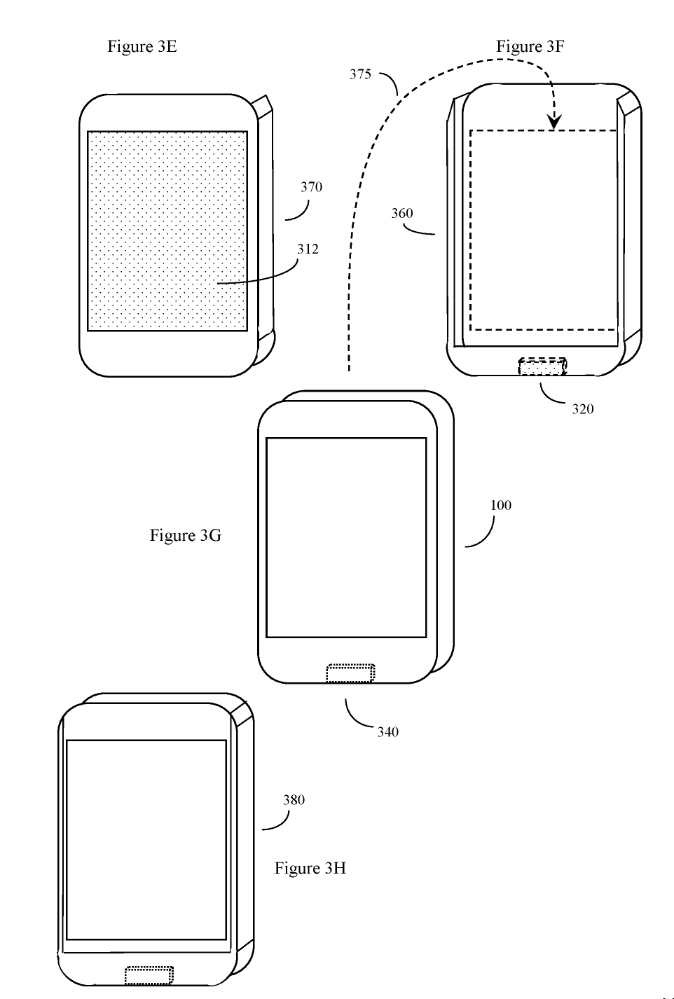

FIGS. 4A and 4B show examples of various alternative embodiments of the detachable touchpad device invention (FIG. 4A, 400), where other types of direct electrical cables, electrical connectors, and wireless links can be used to communicate touch input from the built-in touchpad on the back surface of the detachable touchpad device to the handheld computerized device. In one alternative embodiment, the detachable touchpad device may connect to the handheld computerized device (FIG. 4B, 100) via an audio port connection (402) (403) and a direct wire connection. In another alternative embodiment, the detachable touchpad device may connect to the handheld computerized device via a data port connection (404), (340) and an alternative direct wire connection. In yet another alternative embodiment, the detachable touchpad device (FIG. 4A, 400) may transmit touch information data to the handheld computerized device (100) via a short-range wireless link such as a WiFi or Bluetooth link (406). In some embodiments, the detachable touchpad device may draw or convey power from the handheld computerized device by a wireless power transfer method, such as by the Qi wireless charging standard.

FIG. 5 shows a simple electrical diagram of a handheld computerized device (500) connecting to the invention's detachable touchpad device (520). Here the connection shown is by an optional combination communications power port, connector, or socket, such as the connector/socket arrangement (320)/340 previously shown in FIG. 3A. Alternatively, the connection may be by an entirely wireless (e.g. WiFi, Bluetooth) connection.

The data communications link is shown as (530), and the optional power link is shown as (532). The data communications links will usually be facilitated by appropriate data communications interface circuitry (534), (536) on both sides of the link. This interface circuitry will vary according to the type of data transfer mechanism desired, and may be wireless circuitry (e.g. WiFi, Bluetooth), or data port circuitry according to various protocols (e.g. USB, RS232, FireWire, etc.), and in some embodiments may additionally comprise at least one detachable touchpad device processor to facilitate managing the interface with the handheld computerized device.

Typically one or more microprocessors (502) onboard the handheld computerized device (500) may accept data from the detachable touchpad device's built-in touchpad on the back surface (522) and with the appropriate software (504) (either application software and/or operating system software) residing in memory (506), and in some embodiments in conjunction with touch data from the handheld computerized device's own touch screen (508), control the operation and display (510) of the handheld computerized device.

In some embodiments, such as when wireless data communications is desired, or when the manufacturer and user wishes to take advantage of the ability of the detachable touchpad device to carry a supplemental battery to provide supplemental power to the handheld computerized device, the detachable touchpad device may additionally comprise at least one additional battery (524) that in some embodiments may either draw from and/or supply power to the handheld device's battery (512). Wireless charging circuitry may also be used to help charge this battery (512) as desired.

Thus when the detachable touchpad device is attached to the back side of the handheld computerized device, touch input from the user can be used to control the handheld computerized device.

In a preferred embodiment, the detachable touchpad device's touch sensing pad will act to create or comprise a multi-touch sensing surface capable of recognizing the presence and locations of at least two points of contact with the touchpad or touch sensor surface. Thus when the detachable touchpad device transmits the presence and locations to of these various points of contacts via the data transfer device/interface to the handheld computerized device, software (504) can interpret this multi-touch data and use it to control the handheld computerized device.

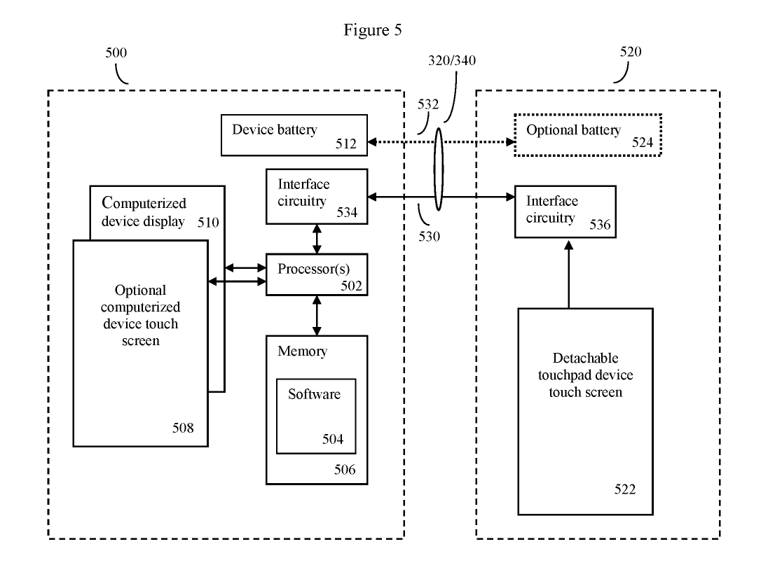

FIGS. 6A and 6B show the user's hand (600) and fingers (602) touching the built-in touchpad on the back surface of the detachable touchpad device (604), and how in the preferred multi touch embodiment, the back touchpad (604) will recognize the position and locations of at least two points of contact between the user's fingers and the back touchpad (606), and transmit this data to the handheld computerized device (130, 350, 100, 500). In this example, software (504) onboard the handheld computerized device (130), (500) may additionally be generating a representation of the approximate locations of the user's fingers (608) on the computerized devices' display screen (104), (510) Here, software techniques and methods such as those taught by Luo in U.S. patent application Ser. No. 12/773,075 and U.S. provisional application 61/327,102, both incorporated herein by reference, may be used.

### Alternative Embodiments

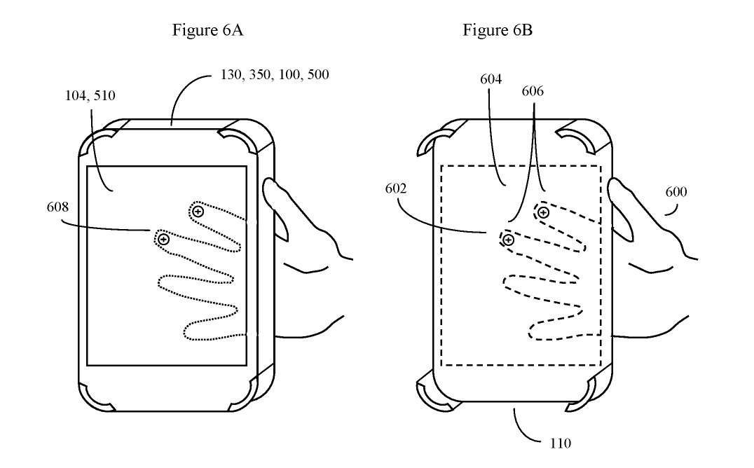

In some embodiments, the detachable touchpad device may be configured to optionally separate into more than one detachable section, and each detachable section can be configured to perform either on its own, or in conjunction with other detachable sections. This type of embodiment can be useful in both one or multiple section situations where, for example, in addition to using the detachable touchpad device for controlling the computerized device from behind (as previously discussed), the user may wish to detach the detachable device (or detachable device section) and continue (for example using a wireless link) to control the handheld computerized device while the detachable device (or device section) is detached from the handheld computerized device. This type of embodiment is shown in more detail in FIGS. 7A and 7B, 8A and 8B, 9A to 9D, and FIG. 10.

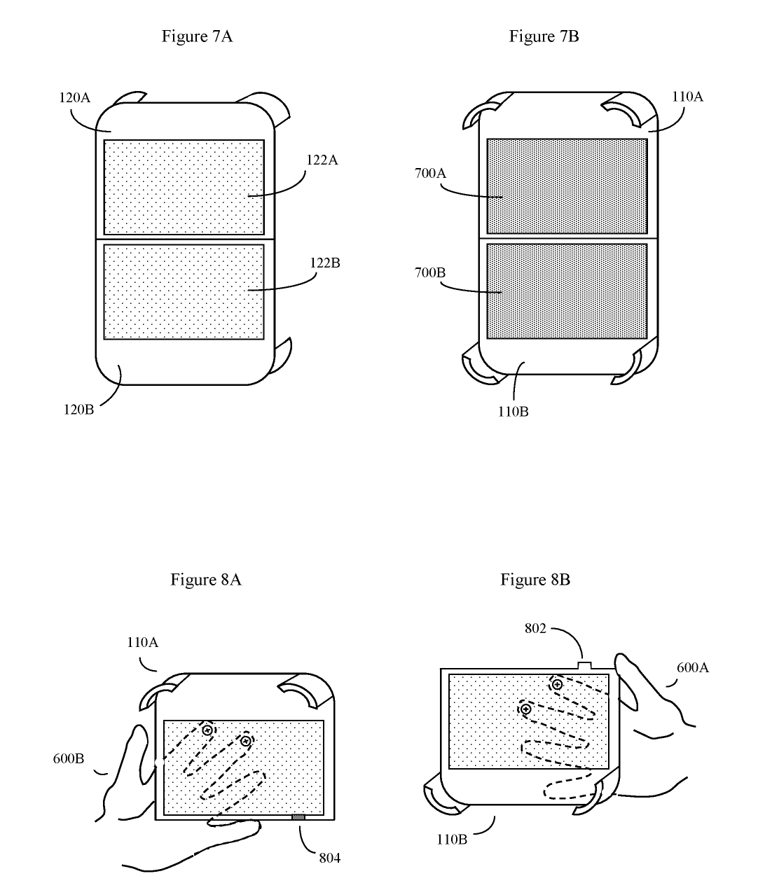

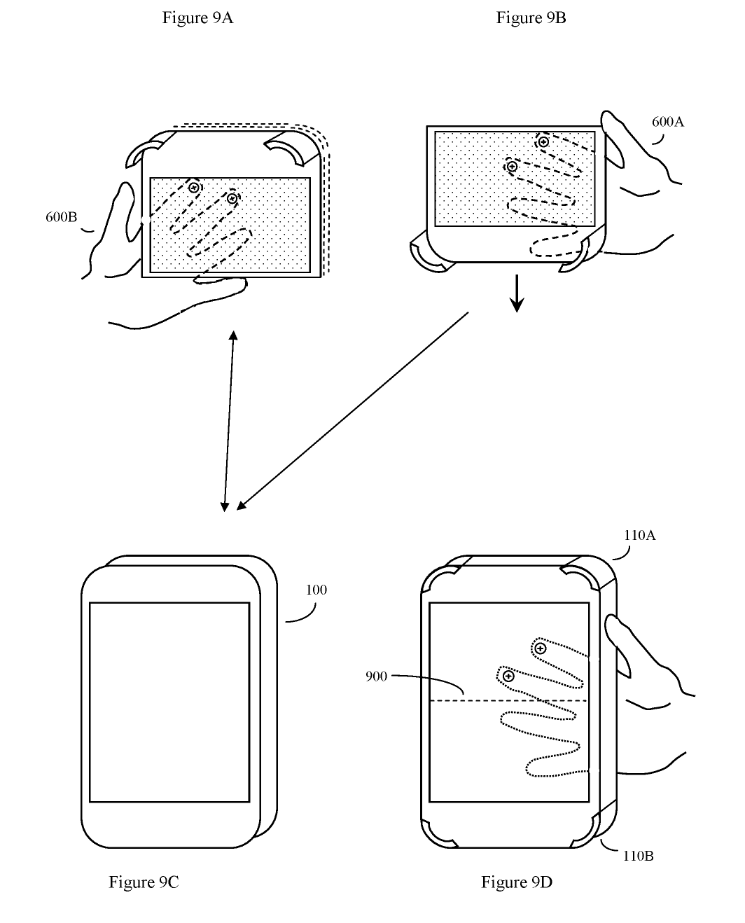

In particular, in some situations, the user may wish to separate the detachable device from the handheld computerized device, and also separate the detachable device (FIG. 1A, FIG. 1B) into two detachable sections (see FIGS. 8A and 8B). The user may then wish to use these two detachable sections (see FIGS. 9A and 9B), while detached from the handheld computerized device (FIG. 9C, 100), as a type of “gamepad” controller, potentially one in each hand (600A, 600b), and control the handheld computerized device in this manner as well.

Here, the more than one detachable sections will typically be configured to be able to combine, at least when both are attached to the handheld computerized device, touchpad signals so as to operate as a single unit or single section (shown in FIGS. 7A and 7B). Here this combination can be done by either processors onboard the sections, processors onboard the handheld computerized device, or both as desired.

For example, each detachable section (120A/110A, 120B/110B) may typically have its own individual (first) touch sensing pad (122A, 122A) that, like (122), are exposed to the user when the detachable sections(s) are attached to the handheld computerized device (100). These various separate touch sensing pads (122A, 122B) may also be configured to electrically combine their signals so that they function as a single (first) touch pad sensing device (122), at least when they are both attached to the handheld computerized device.

These individual touch sensing pads (122A, 122B), which are configured to operate when the detachable sections are attached to the handheld computerized device, can alternatively be referred to as first touch sensing pads.

However when their respective sections are detached from the handheld computerized device (100), each individual (first) touch sensing pad (122A, 122B) in each section may also be electrically configured to present (e.g. wirelessly transmit) the touch signals to the handheld computerized device (100) on either of a combined or individual basis.

Thus to generalize, the detachable touchpad device may comprise at least one detachable section. Often this will be just one detachable section (120/110 described previously) or just two detachable sections (120A/110A, 120B/110B) that can optionally interlock together. However a higher number of detachable sections can also be implemented.

In this embodiment, the detachable touchpad device can be viewed as having, on a per detachable section basis, and per rigid non-foldable cover basis, an opening adapted to reversibly receive the handheld computerized device (100). In other words, as shown in FIGS. 7A, 7B, 8A, 8B and FIG. 9D, in some embodiments, each section can fit onto at least its respective spot on the handheld computerized device.

In this embodiment, the detachable touchpad device can thus comprise at least one section, each section comprising a rigid non-foldable cover (i.e. the cover for the detachable section) including a front side (110, or 110A and 110B) adapted to form a contact with a back side of the handheld computerized device (when this handheld computerized device is inserted in the detachable touchpad device via this opening).

Each detachable section may comprise at least one (first) touch sensing pad (122, or 122A and 122B). At least one of these at least one (first) touchpads will be disposed on a back side (e.g. 120, or 120A and/or 120B) of each detachable touchpad device section's rigid non-foldable cover.

In other words, if there are multiple detachable sections (such as 120A, and 120B), each detachable section may have its own (first) touchpad (122A, 122B) disposed in the backside of that particular detachable section's rigid non-foldable cover. Thus touchpad (122A) will be disposed on the back of 120A, and touchpad (122B) will be disposed on the back of (120B).

As will be discussed, at least some, and sometimes all of the detachable section(s) may also have a second touchpad (700A, 700B) disposed on the front side of that particular detachable section's rigid non-foldable cover as well.

The detachable touchpad device, regardless of the number of sections, will typically have at least one (first) touch sensing pad (e.g. at least 122, and possibly more than one, such as 122A, 122B) if there are multiple detachable sections) adapted to detect a touch input from a user. Note that first touch sensing pad is adapted for use when the detachable touchpad device is attached to the handheld computerized device). This thereby enables the user to control the handheld computerized device using the one or more detachable touchpad device sections. As before this at least one touchpad (e.g. 122, 122A, 122B) will typically be free from mechanically actuated keys.

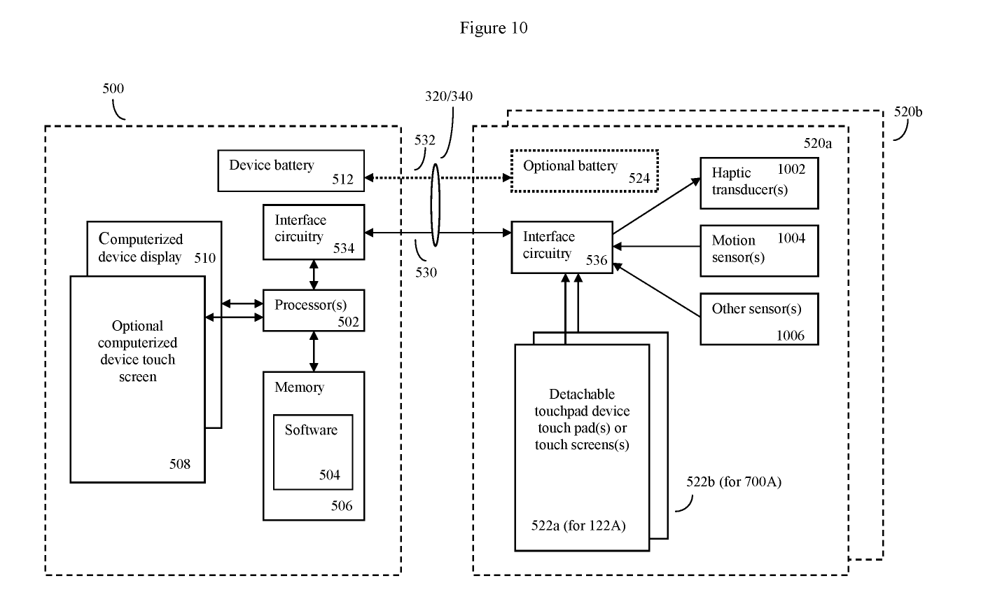

As will be discussed in more detail in FIG. 10, the detachable touchpad device will often have, often on a per detachable section basis, a data transfer device comprising interface circuitry adapted (536), often processor equipped interface circuitry, to transfer data representative of the touch input from that particular detachable touchpad device section to at least one processor of the handheld computerized device. The handheld computerized device processor will typically be adapted or configured (typically by suitable software) to detect and interpret the touch input from the relevant section(s) to then control the handheld computerized device when this touch input data is transferred.

FIG. 7 shows that in some embodiments, the detachable touchpad device may comprise two sections, each with a rigid non-foldable cover (e.g. 120A/110A shown in FIG. 8A, and 120B/110B shown in FIG. 8B), thus essentially splitting the detachable touchpad device into two detachable sections (two detachable touchpad device sections).

Additionally, in some embodiments, the detachable touchpad device may (on a detachable section basis) also comprise a second touchpad (700A, 700B) on the front side of the touchpad device (or each detachable section). This second touchpad may often be hidden or inaccessible to the user (e.g. the body of the handheld computerized device will block access) when the at least one detachable touchpad device section is attached to the handheld computerized device.

However this second touchpad (such as 700A, 700B) will be available for use (e.g. accessible to the user) when the at least one detachable touchpad device section is detached from the handheld computerized device.

This in alternate terminology, this at least one second touch sensing pad (e.g. one second touchpad 700A, 700B per detachable section) may be disposed on the front side (110, 110A, 110B) of any of this at least one section's rigid non-foldable cover (e.g. any detachable section). Further, this at least one second touch sensing pad may be configured to detect a touch input from a user when the user holds this at least one section's rigid non-foldable cover (e.g. that detachable section) detached from the handheld computerized device (FIG. 9C, 100).

Again, as previously described, in some embodiments, the detachable touchpad device may only comprise one section with one rigid non-foldable cover (such as FIGS. 1A and 1B and 110/120). However in alternate embodiments, the detachable touchpad device may comprise two or more detachable sections (FIG. 8A, 110A/120A and (FIG. 8B, 110B/120B), and thus there the detachable touchpad device′ two or more sections will each comprise their own rigid non-foldable cover, and thus the two sections may comprise two or more rigid non-foldable covers.

When the detachable touchpad device comprises multiple sections, such as two sections, the two sections can either be configured so that each section has a rigid non-foldable cover that fits over a different portion of the handheld computerized device, but the various (e.g. two) sections and covers are otherwise not mechanically joined or locked together, except by the handheld computerized device itself forming a natural bridge or join between the two (or more) sections.

Alternatively the various sections can be configured so that the various (e.g. two) section's respective rigid non-foldable covers can also mechanically join or interlock together, at least when the various (e.g. two) section's rigid non-foldable covers are disposed (positioned) on the back side of the handheld computerized device, thus forming a single detachable touchpad device. As shown in FIGS. 8A and 8B, this can be done via various interlocking tabs (802), detents (804), and other various standard fasteners as desired.

Here, typically the various (e.g. two) section's rigid non-foldable covers (e.g. 110A/120A, and 110B/120B) can be configured to easily separate from each other (e.g. preferably without using tools, as shown in FIGS. 8A and 8B), and may be configured for independent operation and communication with the handheld computerized device, at least when not disposed on the backside of the handheld computerized device (100).

When the various sections and their respective covers are disposed on the backside of the handheld computerized device (e.g. FIG. 9D), in some embodiments, the various sections can be configured, at least by software, to then communicate with the handheld computerized device as a single unit, thus making the separate sections act like a single section detachable touchpad device. Put alternatively, the inputs from touchpads (122A) and (122B) can be combined so that the handheld computerized device acts as if touchpads (122A) and (122B) were a single larger touchpad (122). This combination of signals can be done either by the handheld computerized device's processor, or alternatively by the interface circuitry (536) processor onboard the various detachable touchpad device sections.

FIGS. 8A and 8B show an example of a user using a detachable touchpad device with two sections, each with a rigid non-foldable cover (FIG. 8A, 110A, and FIG. 8B, 110B) in the detached configuration, thus essentially creating two detachable touchpad devices. Here the user can, for example, use one detachable device section in a left hand (600B), and the other detachable device section in the right hand (600A).

Most modern handheld computerized devices also have various sensors, such as motion sensors, cameras, fingerprint sensors and the like, and some even have haptic transducers such as haptic transducers configured to make the handheld computerized device vibrate. When the detachable touchpad device is attached to the handheld computerized device, often these handheld computerized device sensors and haptic transducers are adequate by themselves, and thus there may be no need to put additional motion sensors and haptic sensors onboard the detachable touchpad device.

However in some embodiments, the user may also wish to operate the one or more sections of the detachable touchpad device in a detached mode, away from the handheld computerized devices (100). To facilitate use in such a detached mode, the detachable handheld device may additionally also comprise additional devices, such as at least one motion sensor (1004) disposed on some or all of the detachable touchpad device's various sections and their respective rigid non-foldable cover(s).

This at least one motion sensor can comprise one or more of accelerometers, gyroscopes, or infrared sensors, and the like. Some or all of the detachable touchpad device's various sections and their respective rigid non-foldable cover(s) may also comprise haptic transducers, such as haptic vibration units (1002), disposed on any of the at least one sections and rigid non-foldable cover(s). Other sensor devices that some or all of the detachable touchpad device's various sections and respective rigid non-foldable covers may comprise include optical sensors such as video cameras and ambient light sensors, proximity sensors, and fingerprint sensors (1006).

FIGS. 9A and 9B show an embodiment where the detachable touchpad device is further configured to comprise haptic transducers and motion sensors (see FIG. 10 for the electrical schematic). Here one of two detachable touchpad device sections (FIG. 9A) is shown vibrating due to a haptic transducer (1002), while the other detachable touchpad device section (FIG. 9B) is shown detecting user hand motion by way of a motion sensor (1004). In this example, assume that both sections are in wireless communication with the handheld computerized device shown in FIG. 9C.

Thus, for example, if the user was playing a game on the handheld computerized device, both detachable touchpad device sections might each contain haptic transducers (1002) and motion sensors (1004). However in this example, the handheld computerized device may have only triggered or activated the haptic transducer in the section shown in FIG. 9A, and be only detecting hand motion data (from hand 600A) from the section shown in FIG. 9B.

FIG. 9C shows the handheld computerized device, here in (e.g. wireless) communication with the detachable touchpad device sections previously shown in FIGS. 9A and 9B.

FIG. 9D shows that the two detachable touchpad device sections previously shown in FIGS. 9A and 9B can also both be attached to the back of the handheld computerized device, and in this configuration combine their signals to operate as a single detachable touchpad device, as per the configuration previously described in FIGS. 6A and 6B. Here the dashed line (900) shows approximately what part of the touchpad data is coming from the upper section (110A), and what part of the touchpad data is coming from the lower section (110B).

FIG. 10 shows a modified version of the diagram previously shown in FIG. 5, here modified to show how a detachable touchpad device with two sections, each with their respective rigid non-foldable covers can be electrically configured. FIG. 10 also shows how additional components, such as second touchpads, haptic transducers (1002), motion sensors (1004), and other sensors (1006 e.g. fingerprint sensors, proximity sensors, video cameras, ambient light sensors, etc.) may be implemented on a per-section basis.

In FIG. 10, (520a) is an electronic circuit showing the various components in one detachable touchpad device section (such as 110A/120A or FIG. 8A), while (520b) is an equivalent electronic circuit that here is essentially identical to (520a), but shows the electronic components in a different detachable touchpad device section, such as (110B/120B or FIG. 8B).

Further (522a) here refers to the electrical interface for the device's built-in first touchpad (such as 122A) on the back surface of the detachable touchpad device that is accessible to the user when the detachable touchpad device is attached to the handheld computerized device. By contrast (522b) here refers to the electrical interface for an optional built-in second touchpad (such as 700A) on the front service of the detachable touchpad device, which is typically only accessible to the user when the detachable touchpad device is detached from the handheld computerized device.

### Touchpad Hardware:

The touchpad or touch sensors used for this detachable touchpad device can include a variety of different type of touch sensing technologies, such as multi-touch capacitive technology, touch resistive technology, multi-touch optical technologies, or even more exotic touch sensing devices such as touch wave technologies or force based sensing or near field imaging technologies.

Examples of suitable multi-touch capacitive technology include surface capacitive, projected capacitive touch, or in-cell capacitive technologies. Examples of touch resistive technology include analog resistive or digital resistive or in-cell resistive technologies. Example of multi-touch optical technologies include optical or infrared imaging technology, rear diffused illumination, infrared grid technology, digital waveguide touch, or infrared optical waveguide technologies, as well as Kinect or in-cell optical technologies. Examples of touch wave technology include surface acoustic wave or bending wave touch technology.

### Side Mounted Touchpads or Touchscreens:

In some embodiments, in addition to touchpads mounted on the front or back of said detachable touchpad device, it may be useful to further put at least one touchpad or touchscreen on one or more of the sides of the detachable touchpad device. These side mounted touchpads or touchscreens can be used to implement software controlled buttons, for example. This may be further useful for some of the gamepad embodiments, previously discussed. As an example, the corner or side labeled (114) in FIG. 1B may comprise a side mounted touchpad or touchscreen.

Other embodiments may also include embedded radiofrequency identification chips (RFID chips) or near field communications chips embedded in any of the sides of the detachable touchpad device.

Many other peripherals may also be incorporated into the invention's detachable touchpad device, such as lights, one or more speakers and/or ear phone jacks, memory chip interfaces, electrical interface ports, batteries, and the like.

1. A detachable touchpad device having an opening adapted to reversibly receive a non-transparent handheld computerized device, said detachable touchpad device comprising:
at least one section comprising a rigid non-foldable cover including a front side adapted to form a contact with a back side of said non-transparent handheld computerized device when said non-transparent handheld computerized device is inserted in said detachable touchpad device via said opening;
at least one touch sensing pad disposed on a back side of said rigid non-foldable cover of said detachable touchpad device, said at least one touch sensing pad adapted to detect a touch input from a user when said user holds said detachable touchpad device thereby enabling the user to control said non-transparent handheld computerized device using said detachable touchpad device, wherein said at least one touchpad is free from mechanically actuated keys;
and a data transfer device in said detachable touchpad device comprising interface circuitry adapted to transfer data representative of said touch input from said detachable touchpad device to at least one processor of said non-transparent handheld computerized device, said processor being adapted to detect and interpret said touch input to control said non-transparent handheld computerized device when said data is transferred.

2. The detachable touchpad device of claim 1, wherein said at least one section reversibly attaches to at least part of said back side of said non-transparent handheld computerized device, and said rigid non-foldable cover does not cover a device display screen of said non-transparent handheld computerized device.

3. The detachable touchpad device of claim 2, wherein said at least one section reversibly attaches to at least part said back side of said non-transparent handheld computerized device, and said rigid non-foldable cover also covers a portion of said device display screen.

4. The detachable touchpad device of claim 1, wherein a shape of a front side of said rigid non-foldable cover substantially conforms to at least part of a shape of said back side of said non-transparent handheld computerized device.

5. The detachable touchpad device of claim 4, wherein said at least one section's said rigid non-foldable cover reversibly attaches to said non-transparent handheld computerized device by snapping into a position in which a complementary fit between the shape of raised or lowered surfaces on said back side of said non-transparent handheld computerized device and the shape of raised or lowered features on said front side of said rigid non-foldable cover acts to attach said detachable touchpad device to said non-transparent handheld computerized device.

6. The device of claim 1, further comprising at least one motion sensor disposed any of said at least one section.

7. The device of claim 6, wherein said at least one motion sensor comprises any of an accelerometer, gyroscope, or infrared motion sensor.

8. The device of claim 1, further comprising at least one second touch sensing pad disposed on said front side of any of said at least one section's said rigid non-foldable cover; said at least one second touch sensing pad configured to detect a touch input from a user when said user holds said at least one section detached from said non-transparent handheld computerized device.

9. The device of claim 1, further comprising at least one haptic transducer disposed on any of said at least one section's said rigid non-foldable cover.

10. The device of claim 1, further comprising at least one optical sensor disposed on any side of said at least one section's said rigid non-foldable cover.

11. The device of claim 1, further comprising at least one fingerprint sensor disposed on any side of said at least one section's said rigid non-foldable cover.

12. The device of claim 1, wherein said at least one section comprises two said at least one sections, each with said rigid non-foldable cover.

13. The device of claim 12, wherein said two said at least one sections comprise two rigid non-foldable covers configured to mechanically join or lock together, at least when both said two rigid non-foldable covers are disposed on said back side of said non-transparent handheld computerized device; and
wherein said two rigid non-foldable covers are configured to separate from each other and are configured for independent operation and communication with said non-transparent handheld computerized device at least when not disposed on said back side of said non-transparent handheld computerized device.

14. The detachable touchpad device of claim 1, in which said data transfer device communicates said touch input to said non-transparent handheld computerized device via an electrical cable and/or direct electrical connector.

15. The detachable touchpad device of claim 1, in which said data transfer device communicates said touch input to said non-transparent handheld computerized device via a wireless link.

16. detachable touchpad device of claim 1, in which said touch sensing pad comprises a multi-touch sensing surface capable of recognizing a presence and locations of at least two points of contact with said multi-touch sensing surface, and transmitting said presence and locations to said data transfer device.

17. The detachable touchpad device of claim 1, wherein an operating system software or software applications running under said operating system software on said non-transparent handheld computerized device uses said touch input to generate images on a device display screen of said non-transparent handheld computerized device, the images portraying an approximate position of at least some of said user's finger positions and finger movement.

18. The detachable touchpad device of claim 1, wherein a device display screen on said non-transparent handheld computerized device is a touch sensitive device display screen, and in which said non-transparent handheld computerized device is controlled by touch input from both said touch sensitive device display screen and touch input from said detachable touchpad device.

19. The detachable touchpad device of claim 1, wherein any of said at least one section's said rigid non-foldable cover on said non-transparent handheld computerized device additionally comprises a touchpad device battery, and in which said touchpad device battery is configured to either draw power from a handheld device battery, and/or provide power to said handheld device battery.

20. A method of operating a non-transparent handheld computerized device, said method comprising:
providing a detachable touchpad device having an opening adapted to reversibly receive the non-transparent handheld computerized device, said detachable touchpad device comprising:
at least one section comprising a rigid non-foldable cover including a front side adapted to form a contact with a back side of said non-transparent handheld computerized device when said non-transparent handheld computerized device is inserted in said detachable touchpad device via said opening;
at least one touch sensing pad disposed on a back side of said at least one rigid non-foldable cover of said detachable touchpad device, said at least one touch sensing pad adapted to detect a touch input from a user when said user holds said detachable touchpad device thereby enabling the user to control said non-transparent handheld computerized device using said detachable touchpad device, wherein said at least one touchpad is free from mechanically actuated keys; and
a data transfer device in said detachable touchpad device comprising interface circuitry adapted to transfer data representative of said touch input from said detachable touchpad device to at least one processor of said non-transparent handheld computerized device, said processor being adapted to detect and interpret said touch input to control said non-transparent handheld computerized device when said data is transferred.
